(19) United States
(12) Patent Application Publication
(10) Pub. No.: US 2006/0035041 A1
(43) Pub. Date: Feb. 16, 2006

(54) Fastening apparatus and method

(75) Inventors: Gerald V. Flanagan, North Wales, PA (US); Anthony A. Caiazzo, Chalfont, PA (US)

Correspondence Address: Robert S. Lipton, Esquire;LIPTON, WEINBERGER & HUSICK, 201 Norht Jackson Street, P.O. Box 934, Media, PA, 19063-0934, US

(73) Assignee: Materials Sciences Corporation, Horsham, PA (US)

(21) Appl. No.: 10/915,116

(22) Filed: Aug. 10, 2004

(51) Int. Cl. B32B 1/08

(52) U.S. Cl. 428/34.1; 428/36.9

(57) ABSTRACT

The Invention is a fastening apparatus and method for transferring a load to a core of a composite structure, such as a composite panel used in ship construction. The apparatus comprises an insert. The insert is adapted to receive a tension load and adapted to transfer the tension load substantially to the core of the composite structure. The strain response characteristics of the insert in tension generally minimize the strain response of the core in shear.

### FIELD OF THE INVENTION

The Invention is a fastening apparatus for use with composite structures, such as the composite panels used in modern ship construction. The Invention is an apparatus that is bonded to a core of a composite structure to allow a load, such as the load presented by installed equipment, to be carried by the structure. The Invention is also a method of use of the apparatus.

### BACKGROUND OF THE INVENTION

Composite panels are widely used in the construction of modern, ocean-going ships, such as warships. A typical composite panel will consist of an outer skin, an inner skin and a core. The outer and inner skins commonly are composed of a resin, such as polyester resin or other suitable resin, and reinforcing fibers, such as fibers of glass or of carbon. The core is composed of a relatively light and weak material, such as balsa wood or synthetic foam.

The composite panels may form all or portions of the deck, hull or bulkheads of a ship. All of the equipment and machinery necessary to operate a modern ship is attached to the panels. Current techniques for outfitting a composite structure used in ship construction include bonding pads to the skin of the composite structure for lightweight items, the use of pads attached with self-tapping screws for medium-weight equipment and through-bolting once the load limit of the screws is reached. Each of these methods has drawbacks. Bonding is limited in the maximum loads that can be carried, particularly under shock conditions. The major drawback of screws is that the load capability is not easily scaleable. If the load exceeds the load-carrying ability of a single screw, using multiple screws in a limited space may not significantly increase the attachment load capability. Through bolts suffer the disadvantage that the through bolt must be sealed and maintained to prevent moisture intrusion. Through bolts also can have an adverse effect on warship stealth or hydrodynamic performance.

A principal problem of fasteners used to transfer loads to composite panels relates to the bearing of tension loads placed on the fasteners. Depending on the configuration of fasteners used to transfer a load to a composite panel, all or a portion of the fastener may be subject to tension. Overloading a prior-technology fastener in tension can severely damage the base structure of the composite panel by delaminating a large area of skin from the core.

### BRIEF DESCRIPTION OF THE INVENTION

The Invention comprises an insert. The insert may be a hollow, generally cylindrical solid that is closed at one end. The closed end of the insert is adapted so that loads may be applied to the insert. One adaptation to allow loads to be applied to the insert is that a threaded hole such as threads to receive a bolt may be included in the closed end of the insert.

In use, the sides of the insert are bonded to the core of the composite panel in a prepared opening. The insert is not significantly bonded to either the inner or outer skin. Substantially all of a tension load applied to the insert is applied by the sides of the insert to the core of the composite panel. The material from which the sides of the insert are constructed and the thickness of the sides of the insert at each axial location of the insert are selected to allow the insert to deform in a controlled manner in an axial direction in response to tension loads. Specifically, the material from which the sides of the insert are constructed and the thickness of the sides of the insert at each axial location are selected so that the deformation of the sides of the insert produces a near-uniform shear deformation in the core material of the composite panel in response to the load.

The deformation of the sides of the insert achieves near-uniform shear deformation within the core material by reducing the stiffness mismatch between the insert and the core material. The Invention further achieves the near-uniform deformation within the core material by selecting a material and thickness of the closed end of the insert so that the closed end is adequately strong to avoid excessive radial deformation (necking down) of the side walls in response to a tension load while preserving to the extent possible the preferred stiffness relationship between the insert and the core material.

The material and geometric characteristics of the insert reduce stress risers in the core and allows the designer to take full advantage of the strength of the core material in selecting fasteners for ship construction. Experiment has shown that the fastener of the Invention is stronger in tension than a core fastener whose shape and material is not tailored to reduce stress risers. If a fastener of the Invention is overloaded in tension and the connection between the insert and the core fails, the insert pulls out of core with no damage to the outer skin and with minimal damage to the inner skin.

The closed end of the insert includes lobes that bear upon the inner skin when a lateral load exceeding the bearing strength of the core is applied to the insert, further supporting the insert.

### BRIEF DESCRIPTION OF THE DRAWINGS

FIG. 1 is a perspective view of an insert.

FIG. 2 is a top view of the insert of FIG. 1.

FIG. 3 is cross-section A-A of FIG. 2.

FIG. 4 is a cross section of the insert installed in a composite panel.

FIG. 5 is a cross section of the insert being pulled from the panel.

FIG. 6 is a top view of the insert installed in the panel.

FIG. 7 is a perspective view of an insert composed of a polymer.

FIG. 8 is a cutaway view of the insert composed of a polymer.

FIG. 9 is a cross section showing an insert having a side of constant thickness.

FIG. 10 is a cross section showing an insert having a side with an internal taper.

FIG. 11 is a cross section of failure of an insert having a thin first end.

FIG. 12 is a diagram showing shear stress for two first end thicknesses.

FIG. 13 is a cross section of an insert having an irregular side thickness.

FIG. 14 is a cross section of an insert having a side thickness that varies in a step-wise manner.

FIG. 15 is a cross section of an insert composed of a plurality of materials.

FIG. 16 is a cross section of an insert having a plurality of radial grooves.

FIG. 17 is a cross section of an insert defining a helical spring.

FIG. 18 is a cross section of an insert having a plurality of slots.

FIG. 19 is a cross section of an insert having a plurality of longitudinal reinforcing members.

### DESCRIPTION OF AN EMBODIMENT

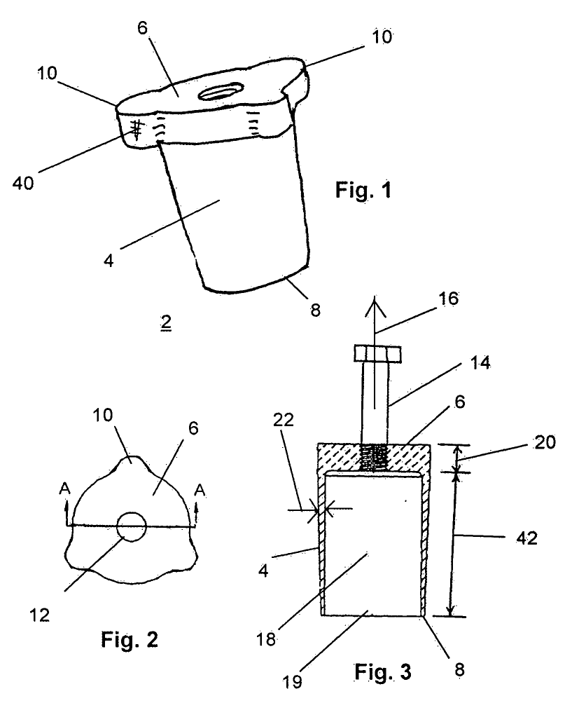

The Invention is illustrated by FIGS. 1, 2 and 3. The fastener of the Invention is insert 2. The insert has a side 4, first end 6 and second end 8. The side 4 is also referred to in this application as side wall 4. The first end 6 is also referred to in this application as the ‘top’ 6. A plurality of lobes 10 are defined by first end 6 of insert 2.

A threaded hole 12 appears in first end 6 of insert 2. The threaded hole 12 may receive bolt 14, and is one possible way to transfer a load 16 to insert 2. All other possible ways to transfer a load 16, which may be a tension load, to the insert 2 also are contemplated by the Invention, such as welding, welding studs, threaded studs, hooks, brackets or other mechanical fasteners, adhesives, magnets, and all other attachment means.

FIG. 3 is cross section A-A of FIG. 2. As illustrated by FIG. 3, insert 2 is generally in the shape of a hollow cylinder and defines interior volume 18. First end 6 has a top thickness 20. Side wall 4 has thickness 22. Side wall thickness 22 may vary along the axial dimension of insert 2. Second end 8 of insert 2 defines opening 19.

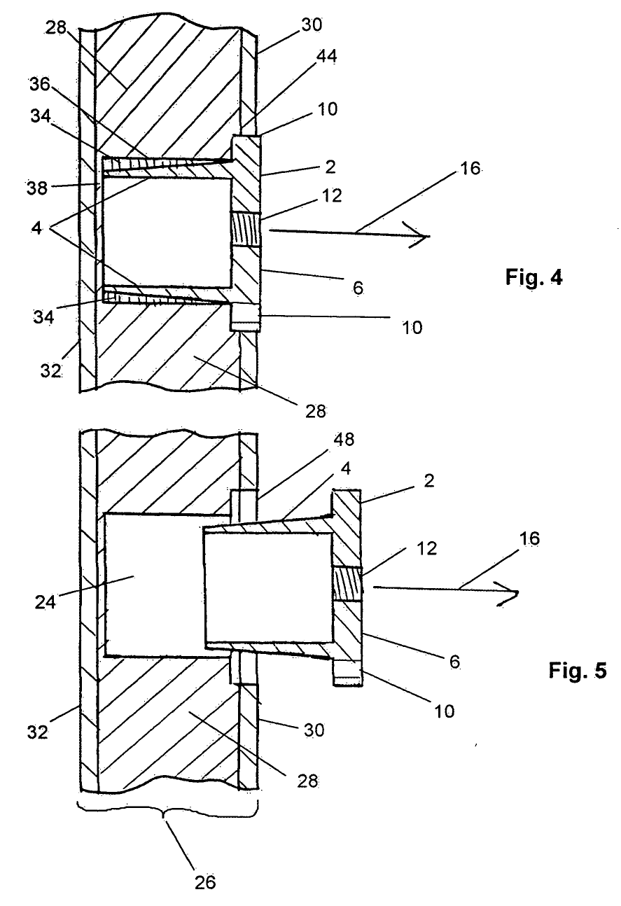

In use and as shown by FIGS. 4 and 5, insert 2 is bonded within a prepared opening 24 in a composite structure 26. Composite structure 26 as used in ship construction comprises a core 28, an inner skin 30 and an outer skin 32. Core 28 is composed of a relatively light and weak material, such as balsa wood or synthetic foam. Inner skin 30 and outer skin 32 generally are composed of a suitable resin reinforced with fibers of glass or carbon.

A suitable adhesive 34, such as epoxy glue, binds insert 2 into opening 24.

The connection between adhesive 34 and core 28 is referred to in this application as the ‘bond line’ 36. Insert 2 is not bonded to outer skin 32, and a thin layer 38 of core 28 separates insert 2 and outer skin 32.

Insert 2 also is not bonded to inner skin 30. When opening 24 is prepared, inner skin 30 is cut away to provide clearance for top 6 and lobes 10 of insert 2.

In addition, a release coating 40, shown by FIG. 1, appears upon the portions of insert 2 that might otherwise be bonded to inner skin 30. The combination of the release coating 40 and the clearance provided for lobes 10 and top 6 prevents insert 2 from being bonded to inner skin 30.

Some residual bonding may occur between inner skin 30 and insert 2 and between outer skin 32 and insert 2 despite the use of release coating 40, clearance for top 6 and thin layer 38 of core 28; however, no significant load is applied to inner skin 30 or outer skin 32 by insert 2 and substantially all of the pull-out load 16 is transferred to core 28.

When a pull-out load 16 is placed on the first end 6 of insert 2, as shown by FIG. 4, the first end 6 transfers the pull-out load 16 to sides 4. The sides 4 are placed in tension by load 16. The side 4 of the insert 2 exhibits an elastic deformation in response to the tensile stress imposed by load 16 and the length 42, shown by FIG. 3, of the side 4 of insert 2 increases as a result of the tensile stress. The sides 4 transfer the load 16 to the adhesive 34 and hence to the core 28 at the bond line 36. Core 28 experiences load 16 as a shear stress applied by the adhesive 34. Core 28 exhibits elastic deformation in response to the shear stress applied by the sides 4 of insert 2. As shown by FIG. 5, when the pull-out load 16 is increased beyond the strength of the core 28 to support the load 16, the core 28 fails at the bond line 36 and insert 2 is pulled from opening 24 with little or no damage to the outer and inner skins.

As described below, the first end 6 and sides 4 of insert 2 are configured so that the deformation of side 4 of insert 2 maximizes the uniformity of the elastic shear strain in the core 28. The strain uniformity along the length of sides 4 and core 28 reduces stress concentrations in the core and at the interface 44 between the core 28 and the inner skin 30, resulting in higher pull-out loads 16 before failure.

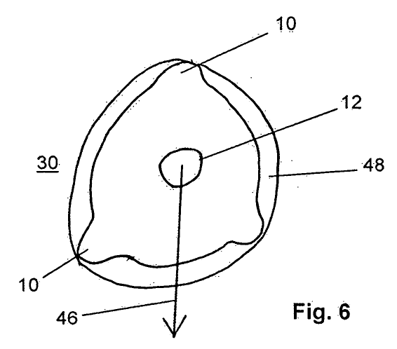

As shown by FIG. 6, the configuration of first end 6 allows the insert 2 to support lateral loads 46, that is, loads parallel to the surface of outer skin 30. As shown by FIGS. 4-6, a first end relief opening 48 is cut through inner skin 30. The first end relief opening 48 is sized to allow lobes 10 of insert 2 to clear the inner skin 30 when insert 2 is bonded within the prepared opening 24. Lobe 10 bears upon inner skin 30 in response to lateral load 46, transferring at least a portion of lateral load 46 to inner skin 30 and substantially increasing insert's 2 ability to support the lateral load 46. Release agent 40 in conjunction with first end relief opening 48 prevents first end 6 from bonding to inner skin 30.

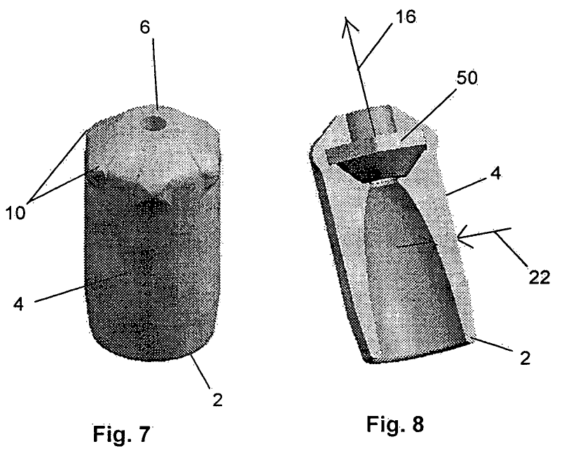

The insert 2 illustrated by FIGS. 1-6 is composed of a relatively stiff, strong material, such as steel. Inserts may be composed of any suitable material, such as a polymer or reinforced polymer. FIGS. 7 and 8 illustrate a reinforced polymer insert 2. Load 16 is transferred to a steel fastening member 50, which is imbedded in the insert 2. The steel fastening member 50 transfers the load to side 4, which is bonded to core 28. The polymer is selected and the first end 6 and side 4 of insert 2 are configured so that the elastic strain characteristics of side 4 in response to a tensile load 16 minimizes the elastic strain of core 28 in shear.

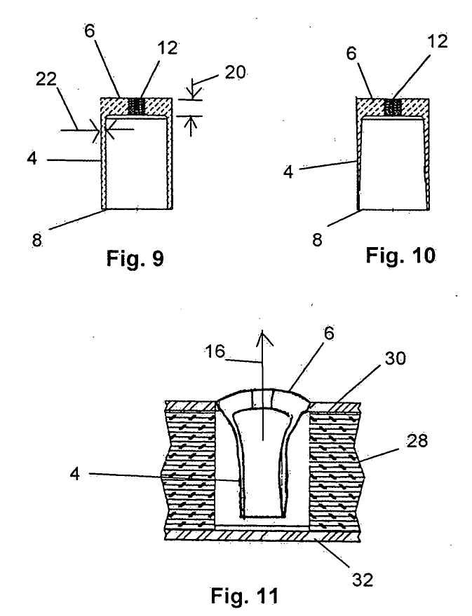

Stress analyses were conducted to assess how the geometry of the insert 2 and bond line 36 affects load 16 transfer from the insert 2 to the core 28. Variables studied included:
The study examined inserts 2 with uniform side wall 4 thickness 22, shown by FIG. 9, as well as insert 2 specimens with an side wall 4 outside taper, shown by FIG. 3, and side wall 4 inside taper, shown by FIG. 10.
Designs for inserts 2 having a length 42 extending to the outer skin 32 and designs that terminated short of the outer skin 32 at varying gaps were explored.
Overall thickness 22 of the insert side wall 4 was examined. Thin side wall 4 inserts 2 and solid inserts 2 having no interior space 18 were studied to determine the effect on the resulting shear response along the bond line 36.
The thickness 20 of the insert top 6 was varied to look at how this variable affected stress concentrations.
Interaction of the inner skin 30 of the composite structure 26 with the insert 2 was examined. The benefits suggested for an insert 2 not directly bonded to the inner skin 30 of the composite structure 26 were further studied.

The design process focused on distributing the shear stress uniformly across the bonding surface (the side 4) of the insert 2 by varying the design parameters in parametric studies. Parametric design studies conducted using finite element analysis software led to an optimized insert that could be applied to a number of similar applications, much the same way a particular threaded fastener could be used in a number of not necessarily optimal applications. Other applications include joints, tie downs, antenna locators, lighting fixtures and others.

The glass fiber reinforced polymer optimized insert 2 is shown by FIGS. 7 and 8. For a 3″ thick balsa wood core 28, the insert 2 of FIGS. 7 and 8 is nominally 2″ in diameter and includes a ½″ diameter thread pattern for engaging the fastener 14. The insert 2 weighs approximately 0.7 pounds. Experiments have shown that the optimized insert 2 develops a pull-out strength equal to a ½ ″ diameter through bolt.

1.1 Basic Wall Geometry

Three insert 2 designs are economical for a metallic insert and are shown by FIGS. 9-11: a uniform side wall 4 thickness 22 (FIG. 9), a taper on the outside surface of the side wall 4 (FIG. 3), and a taper on the inside surface of the side wall 4 (FIG. 10). Both the inside and outside side wall 2 taper designs, in general, performed better than the uniform side wall 4 insert 2, but because of scatter in the data, the exact benefit of the taper was inconclusive. To determine the benefit, if any, outside tapers of from zero degrees to 3.7 degrees and a wall 4 thickness of 0.25 inches prior to tapering were studied for a steel insert 2 bonded to a composite structure 26 having a balsa wood core 28. Corrosion resistant steel (CRES-304) was used to manufacture the insert. The composite panel skins were 0.25″ thick and the core was 3″ thick. It should be noted that since the insert derives all of its strength from the core, the results are known to be independent of the composite skin material.

The slope of the outside side wall 4 taper had a noted effect on the predicted stress concentrations within the core 28 at the bond line 36 between the insert 2 and the core 28. The general shape of the stress concentration plots along the bond line 36 did not change with the slope of the taper, but tapers with a greater slope significantly reduced the stress concentrations seen at the interface 44 of the inner skin 30 and core 28, shown by FIG. 4, as well as the stress concentrations within the core 28 at the second end 8 of the insert. In addition, the tapered side wall 4 seemed to help bring the shear profile to the expected average much quicker than the uniform thickness side wall 4, showing less oscillation in the stress concentration profile before settling on the average. This was significant in achieving a more uniform shear stress distribution along the bond line 36.

In addition, the sensitivity of the taper variable was studied over a range of values of from zero to 3.7 degrees to determine if there were any benefits to an “optimized” taper or whether simply having any taper was adequate. The data suggest that varying the taper within the studied range does not have a significant effect on stress concentrations at the interface 44 between the inner face 30 and the core 28, but does affect stress concentrations at the second end 8 of the insert 2. As the side wall 4 taper is increased, the shear stress concentration within the core 28 at the second end 8 of the insert 2 will decrease. An insert 2 with a larger side wall 4 taper could help significantly reduce the stress at the second end 8 of the insert 2. This is important since fracture analysis suggests that the connection between the insert 2 and the core 28 is most likely to fail at the second end 8 of the insert 2. Physical testing also supports this conclusion, as the inserts 2 with an outside taper demonstrated the best tensile load 16-carrying capacity.

1.2 Insert Length

Analysis of composite structures 26 suggests that stress concentrations will exist where there is a material mismatch in the structure. Consequently, one can expect that the interaction of the insert 2 with the outer skin 32 of the composite structure 26 will affect the stress behavior at the second end 8 of the insert 2.

The data show that an insert 2 with a length 42 that approaches the depth of the core of the composite panel without making direct contact with the outer skin 32 of the panel 26 showed the lowest stress concentrations and hence the greatest ability to resist pull out. A thin layer 38 of core 28 left between the second end 8 of insert 2 and the outer skin 32 to prevent bonding of the insert 2 and outer skin 32 achieved the optimum result. The trend of the stress concentration at the second end 8 of the insert 2 is nearly linear, which allows for prediction of stress concentrations in inserts 2 that vary only by their lengths.

The study also examined the effect of bonding the insert 2 to the outer skin 32. An insert 2 bonded to the outer skin 32 exhibited a stress concentration in the core 28 at the second end 8 of the insert 2 where the second end 8 made physical contact with the outer skin 32. The insert 2 bonded to the outer skin 32 also suffered from a shear stress profile that did not converge to the average, making it difficult to predict failure. The stress concentrations observed were similar to those seen at the bi-material interface 44 of the inner skin 30 and the core 28 of the composite structure 26. Bonding of the insert 2 to the outer skin 32, while certainly possible, should not be considered desirable given the much better response characteristics of the inserts 2 with that are not bonded to the inner or outer skins 30, 32.

1.3 Insert Side Wall Thickness

The effects of varying the side wall 4 thickness of the insert 2 were studied.

The study results demonstrated that minimizing the wall 4 thickness of the insert 2 helped to reduce the stress concentrations, particularly those seen at the bi-material interface 44 of the inner skin 30 and the core 28. Reducing the wall 4 thickness increased the “hollowness” of the insert 2 and effectively reduced the stiffness of the insert 2, minimizing the stiffness mismatch between the balsa core 28 and steel insert 2.

An examination of the effect of insert side wall thickness 22 in conjunction with other variables, such as insert top thickness 20, revealed that thinner insert walls 22 do not always yield a lower stress at the bi-material interface 44 between the inner skin 30 and the core 28. In some cases, thinning the wall 4 of the insert 2 made an effectively manageable stress profile exhibit catastrophic stress concentrations. This result suggests that additional variables influence the effect of side wall thickness 22 on the stress profile. The most critical of these variables affecting wall thickness 22 is insert top thickness 20.

1.4 Insert Top Thickness

Studies on the insert top thickness 20 demonstrated that the insert top thickness 20 plays a vital role in determining whether thinning the walls 4 of an insert s will be a benefit or a detriment to the overall shear stress profile. If the first end (top) 6 is either too thick or too thin, thinning the side wall 4 hurts, rather than helps, the shear stress response. If the first end 6 is too thick, the insert 2 acts like a solid rod and the stiffness mismatch between the core 28 and insert 2 creates a stress concentration at the bi-material interface 44 between the inner skin 30 and the core 28, resulting in premature failure.

As illustrated by FIG. 11, if the top 6 is too thin, the insert 2 is subjected to a significant amount of radial displacement at the bi-material interface 44. When a pull-load 16 was applied to a steel insert 2 having a thin side wall 4 and a thin top 6, the smaller cross-sectional area of the thin top 6 deformed easier and to a greater degree at lower applied loads 16 than a thicker top 6. As the top 6 “bowed” in response to the pull-load 16, the side walls 4 of the insert 2 attempted to “pinch” inward and deflect, resulting in a radial displacement of the insert 2 away from the core 28. At the same time, the epoxy adhesive 34 bonding the insert 2 to the core 28 resisted this displacement, creating a stress concentration in the core 28 at the point where the insert side wall 4 began to pull away from the core 28. This behavior was amplified as the first end 6 of the insert 2 was thinned, since a thinner metal has less stiffness to counteract the applied pull-load 16 and resist bending. These results suggest that top thickness 20 is an important design variable.

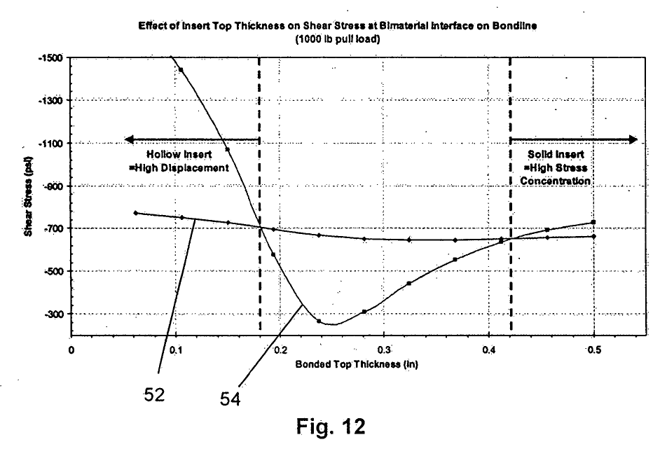

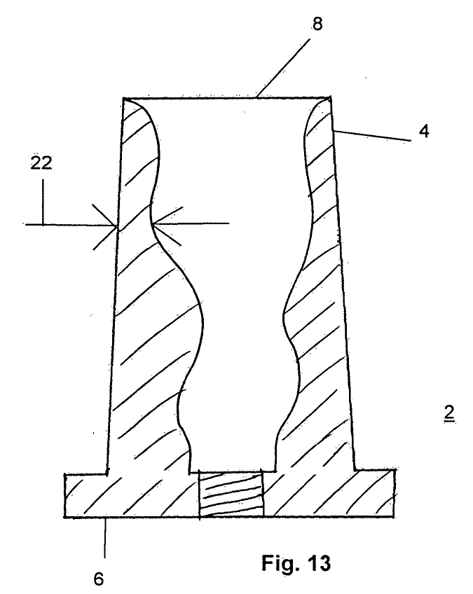

A global sensitivity study was performed of the effect of the variable of insert top thickness on stress concentration at the interface 44 between the inner skin 30 and core 28 for two different values of side wall thickness (0.25 and 0.0625 inches) and a pulling load of 1000 pounds. The results for a top thickness of 0.25 inches appear as element 52 on FIG. 12, while the results for a top thickness of 0.0625 inches appear as element 54 on FIG. 13. FIG. 12 demonstrates that there is a certain range of insert top thicknesses 20, viz., 0.18 to 0.42 inches that minimizes the stress concentration at the bi-material interface 44 between the inner skin 30 and the core 28 for the side wall thicknesses 22 and load 16 examined. FIG. 13 demonstrates that if the top 6 is too thick or too thin, stress concentrations increase.

FIG. 12 also shows that the opportunity exists to gain the most benefit from thinning the walls 4. For example, if the top thickness 20 was 0.4 inches, a stress concentration of approximately 650 pounds per square inch (psi) at a ¼″ wall 4 thickness could be reduced to around 620 psi by thinning the walls 4 to 1/16″. However, if the top thickness 20 was 0.25 inches, rather than 0.40 inches, the stress concentration could be reduced from about 660 psi to around 250 psi. Clearly, optimizing the top thickness 20 provides a significant opportunity to take advantage of making an insert 2 with a thinner wall thickness 22.

1.5 Inner Skin Interaction

Failure in composite structures 26 often occurs when the inner skin 30 de-laminates from the core 28. This is frequently seen in threaded fastener attachments, such as self-tapping screws, and is costly to repair because the damage is not localized. In providing this new method for attaching fixtures to composite panels 26, one goal is to minimize the damage done to the panels 26 when the connection of the insert 2 to the core 28 ultimately fails. One way this can be accomplished is to counter bore the inner skin 30 to a slightly larger diameter than the core 28 as illustrated by FIG. 6 to prevent bonding of the insert 2 to the inner skin 30. This also allows for the insert 2 and residual epoxy to be pulled cleanly away from the composite structure 26 in the event of failure without interfering with the inner skin 30. Test and analytical results show a significant benefit to trimming the inner skin 30 to avoid adhesive bonding with the insert 2.

There are, however, disadvantages to trimming the inner skin 30 from the insert 2. Specifically, one of the key functions of the inner skin 30 is to provide adequate stiffness for the support of a lateral load 46 on the insert 2, shown by FIG. 6. This is especially critical for applications to the shipbuilding industry, where an insert 2 may be affixed to a composite structure 26 used as a sidewall and fixtures may be mounted to the insert 2. These inserts 2 experience lateral loads 46 acting parallel to the inner skin 30. If the insert 2 is unable to bear upon the inner skin 30 and to transfer the load 46 to the inner skin 30, the insert 2 may have a very poor response to a lateral load 46.

The research program has demonstrated that an insert 2 using a thin, tapered outside wall 4 and optimized top thickness 20 exhibit significantly lower stress concentrations at the interface 44 between the inner face 30 and the core 28 and significantly lower stress concentrations at the second end 8 of the insert 2 than exhibited by a rigid, solid insert 2. An insert 2 that is bonded to the core 28 but not to the inner or outer skin 30, 32 of the composite structure 26 is the best design.

An insert 2 with an outside taper that was not bonded to the inner or outer skin 30, 32 of the composite structure 26 exceeded the predicted shear strength of the balsa wood core 28 material. This result demonstrates that the design is effective at reducing stress concentrations. The test results of steel inserts 2 that were bonded to the core 28 but not to the inner or outer skins 30, 32 of the composite structure 26 achieved loads 16 close to the theoretical loads 16 predicted by finite element analysis models and shear strength calculations.

As illustrated by FIG. 5, test results demonstrated that overloading of inserts 2 bonded to the core 28 of a composite structure 26 by a fully cured adhesive exhibit a benign failure with very little damage to the composite structure 26. The failure is the pulling out of plugs of core 28 with minimal damage to the inner skin 30 and without the delamination common in the case of failure of a threaded fastener connection.

FIGS. 13-19 illustrate additional configurations for the side 4 of insert 2 to achieve a controlled strain along the length 42 of side 4 in response to load 16. FIG. 13 shows a side 4 with a thickness 22 that varies irregularly along the axial direction of insert 2 and may be applicable, for example, in the situation of a core 28 that is not homogenous. FIGS. 3, 4, 5 and 10 illustrate a side thickness 22 that varies in the axial direction consistent with a smooth taper. FIG. 8 illustrates a thickness 22 that varies axially to accommodate the strain characteristics of a polymer from which the insert 2 is composed.

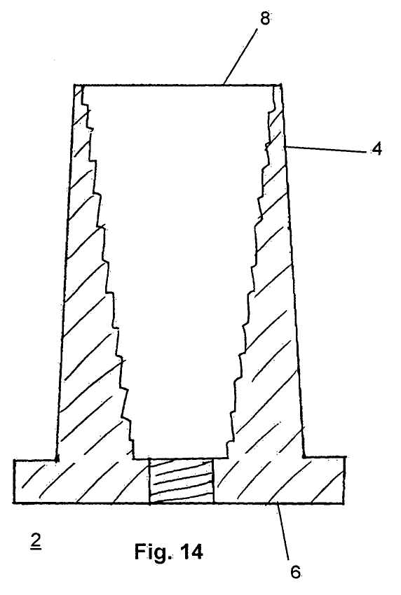

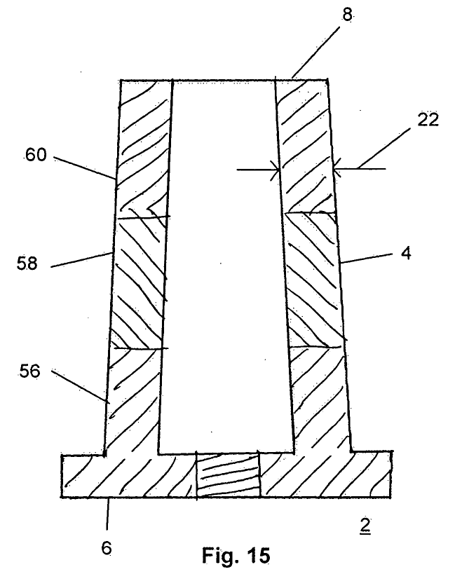

FIG. 14 illustrates a side 4 that varies in thickness 22 in a step-wise fashion to achieve a desired strain response. FIG. 15 illustrates an insert 2 that is composed of a plurality of materials 56, 58, 60 that are selected to achieve desired insert 2 strain characteristics. The plurality of materials 56, 58, 60 may be combined with changes in side thickness 22 to achieve desired strain characteristics.

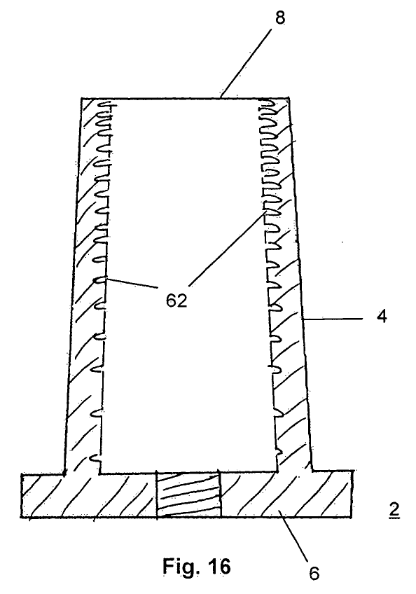

FIG. 16 illustrates an insert 2 having a plurality of grooves 62 defined by the side 4 of the insert 2. The grooves 62 effectively thin the side 4 and control the local stiffness of the side 4 in tension, allowing the local stiffness, and hence the local strain, of the side 4 to be varied along the axial dimension. In the insert 2 illustrated by FIG. 16, the greater number and depth of grooves 62 in the vicinity of second end 8 than in the vicinity of first end 6 renders side 4 in the vicinity of second end 8 less stiff than the side 4 in the vicinity of first end 6.

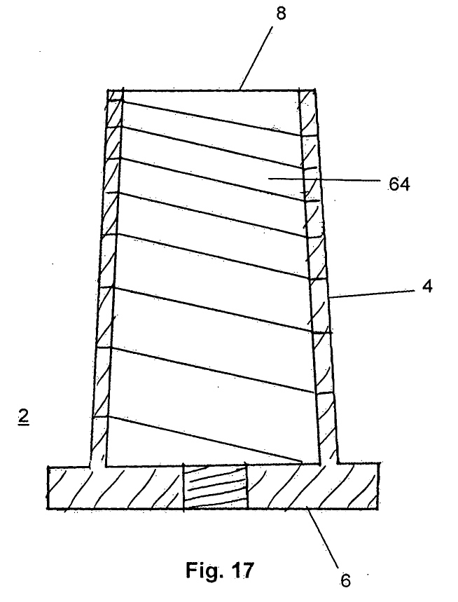

FIG. 17 illustrates an insert 2 defining a helical spring 64. The dimensions of helical spring 64 may be locally varied to control the local stiffness, and hence the local strain, of side 4 in response to load 16.

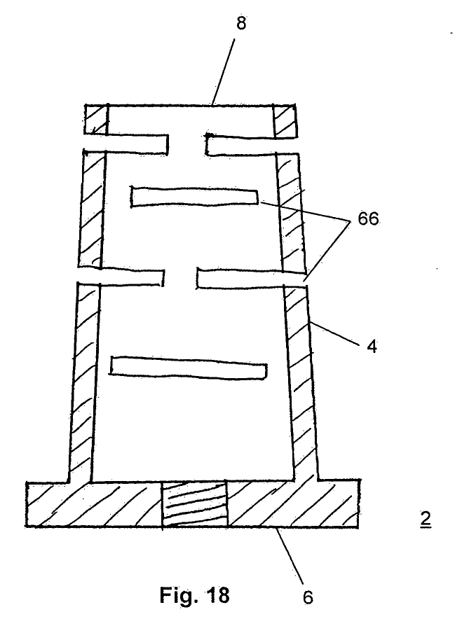

FIG. 18 illustrates in insert 2 having a plurality of slots 66 defined by the side 4. The number and spacing of the plurality of slots 66 control the local stiffness of side 4, and hence the local strain of wall 4 in response to load 16.

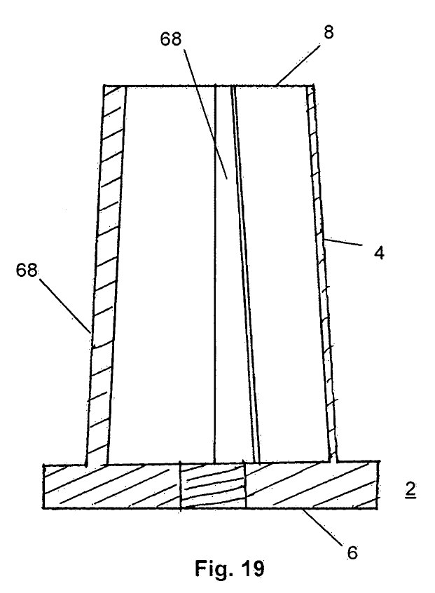

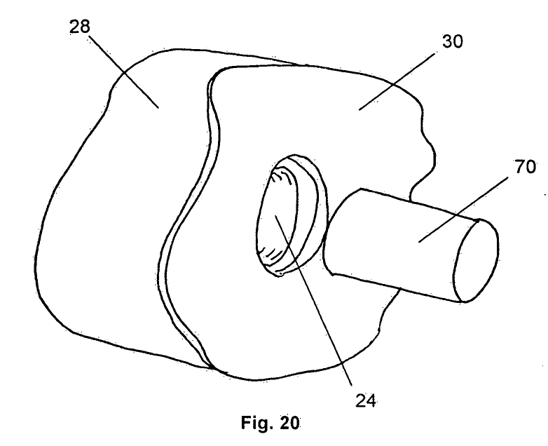

FIG. 19 illustrates an insert 2 having a plurality of longitudinal reinforcing members 68. The insert 2 of FIG. 19 has a thin side wall 4, which, without reinforcement would not have adequate stiffness. Longitudinal reinforcing members 68 have dimensions that vary in the axial direction of insert 2. The longitudinal reinforcing members 68 therefore provide controlled reinforcement to side 4 to achieve a desired stiffness, and hence strain, in the axial direction in response to tension load 16.

Each of the illustrations above shows the variations in dimensions occurring on the interior of the insert 2. All features illustrated on the interior of insert 2 may appear on the exterior of insert 2.

As used in this application, the term “hollow cylinder” in reference to an insert 2 means an insert 2 having a side wall 4 with a generally circular cross section normal to the axial dimension of the side wall and defining an interior volume 18. Each of the inserts 2 illustrated by FIGS. 1-11 and 13-19 is a “hollow cylinder” within the meaning of this application.

As used in this application and as illustrated by FIG. 20, the term “plug” 70 means a piece of core 28 material of the size and shape that is removed from the composite structure 26 in preparing the opening 24 to receive the insert 2. The Invention successfully minimizes the load-induced stresses within the core 28, and increases the load-carrying capacity of the insert 2, by matching as closely as possible the deformation characteristics of the insert 2 to the deformation characteristics of the plug of core 2 material that the insert 2 replaces.

The material from which the insert 2 is composed and the material from which the core 28 is composed each has a modulus of elasticity. The modulus of elasticity is a characteristic of the material and generally is defined as the ratio of the applied stress per unit area to the change in unit length of the material in response to the stress. The plug of core 28 material and the insert 2 each has a “stiffness,” which is the product of the modulus of elasticity and the cross sectional area of the plug or of the insert 2 normal to the applied stress. The goal is to match the stiffness of the insert 2 to the stiffness of the plug as closely as possible for each location along the axial length of the insert 2.

As discussed above, the matching of the stiffness of the insert 2 and plug is constrained by (a) the need to transfer a load 16 to the insert 2 and (b) by radial deformation of the insert 2. As to (a), the top 6 of the insert 2 must be adequately robust to receive the entire externally-applied load 16 without excessive deformation. Excessive deformation of the top 6 of the insert 2 in response to the load 16 will cause deformation of the side wall 4 of the insert adjacent to the top 6. Deformation of the side wall 4 will tend to pull the side wall 4 of the insert 2 away from the sides of the opening 24 to which the insert 2 is bonded, creating a stress riser at the side bond line 36 and potential failure.

As to (b), a tension load 16 applied to the insert 2 (or any other object) causes the insert 2 to “neck down” or reduce in cross-sectional area normal to the direction of the applied load 16. The “necking down” of the insert 2 causes the insert 2 to tend to pull away from (and hence to apply stress to) the bond line 36 between the insert 2 and the core 28. The combination of the stress applied by the “necking down” of the insert 2 and stress of the load 16 transferred to the core 28 by the insert 2 creates stress risers and potential failure at the bond line 36.

The design constraints discussed cooperate to prevent the stiffness of the insert 2 from being uniform along its length and ensure that the minimization of the various stresses acting on the core 28 at the bond line 36 involves complex computations involving several variables. Finite element analysis lends itself to analysis of stresses in such a structure using techniques well known in the art. Finite element analysis was used to configure the insert 2 so as to minimize the stresses at the bond line 36. Finite element analysis may be used to configure an insert 2 composed of any material, so long as the material has a modulus of elasticity that is greater than the material from which the core is composed.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. A fastening apparatus for transferring a tension load to a composite structure, the apparatus comprising: an insert, said insert being adapted to receive the tension load, the composite structure having a core, said insert being adapted to transfer substantially all of the tension load to said core.

2. The fastening apparatus of claim 1 wherein said insert has a side, a first end and a second end, said adaptation of said insert to transmit substantially all of the tension load to said core comprising: said side of said insert being adapted to be adhesively bonded to said core.

3. The fastening apparatus of claim 2 wherein said side defines generally a hollow cylinder.

4. The fastening apparatus of claim 3 wherein said adaptation of said insert to receive the tension load comprising: a top defined by said first end of said insert, said top being adapted to receive the tension load.

5. The fastening apparatus of claim 4 wherein said hollow cylinder defines a taper.

6. The fastening apparatus of claim 4 wherein said side is composed of a plurality of side materials.

7. The fastening apparatus of claim 4 wherein said side defines a plurality of slots.

8. The fastening apparatus of claim 4 wherein said side of said insert defines a helical spring.

9. The fastening apparatus of claim 4 wherein said side of said insert defines a plurality of longitudinal reinforcing members.

10. The fastening apparatus of claim 4 wherein said composite structure has an inner skin, said top defines a skin impinging portion, said skin-impinging portion being adapted to bear upon said inner skin in response to a lateral force received by said insert.

11. The fastening apparatus of claim 10 wherein said skin-impinging portion comprises a lobe.

12. The fastening apparatus of claim 11, further comprising: a release agent applied to said lobe.

13. The fastening apparatus of claim 2 wherein the composite structure has an inner skin and an outer skin and said insert is adapted not to be bonded to said inner skin or to said outer skin.

14. The fastening apparatus of claim 13 wherein said adaptation of said insert not to be bonded to said outer skin comprises: said side of said insert having a length, said core of the composite structure having a core thickness, said length being selected such that said length is less than said core thickness.

15. The fastening apparatus of claim 14 wherein said insert defines a lobe, said lobe being adapted to bear upon said inner skin in response to a lateral force applied to said insert, said adaptation of said insert not to be bonded to said inner skin comprising: a release agent appearing between said lobe and said inner skin.

16. A fastening apparatus for transferring a tension load to a composite structure having a core, the apparatus comprising:
a. an insert, said insert being adapted to accept the tension load;
b. a side wall defined by said insert, said insert having an axial dimension, said side wall defining a plurality of side wall locations along said axial dimension, said side wall having a pre-determined stiffness at each of said side wall locations, said pre-determined stiffness being selected to introduce a substantially uniform shear stress in the core in response to the tension load when said insert is bonded to the core.

17. The fastening apparatus of claim 16 wherein said side wall of said insert has a thickness, said side wall of said insert being composed of a material, said material being selected and said thickness of said side wall being selected to define said pre-selected stiffness of said side wall at each of said plurality of side wall locations.

18. The fastening apparatus of claim 17, further comprising:
a. a first end defined by said insert, said adaptation of said insert to receive the tension load comprising said first end being adapted to receive the tension load, said first end and said side wall of said insert together defining an interior volume;
b. a second end defined by said insert, said second end defining a second end opening.

19. The apparatus of claim 18 wherein the composite structure has an inner skin and an outer skin, said first end of said insert defining a lobe, said lobe being adapted to contact said inner skin in response to a lateral load applied to said first end of said insert, whereby a portion of said lateral load is supported by said inner skin.

20. The apparatus of claim 19, further comprising: a release coating, said release coating appearing between said lobe and said inner skin, said release coating preventing said insert from bonding to said inner skin.

21. The apparatus of claim 20 wherein said core has a core thickness, said insert is adapted not to be bonded to said outer skin, said adaptation of said insert not to be bonded to said outer skin comprising said side of said insert having a length, said length of said side being selected to be less than said core thickness.

22. A method of transferring a load to a composite structure having an inner skin, a core and an outer skin, the method comprising the steps of:
a. preparing an opening in the inner skin and the core;
b. adhesively bonding an insert within said opening, said insert having a first end and a side wall, said first end being adapted to receive the load, said side wall being bonded to said core, said insert not being bonded significantly to said inner skin or to said outer skin.

23. The method of claim 22 wherein said insert has a stiffness, said stiffness of said insert being pre-selected.

24. The method of claim 23 wherein said pre-selection of said stiffness comprising application of design means to substantially minimize a stress within said core in response to a tension load applied to said first end of said insert when said insert is bonded to the core.

25. The method of claim 24 wherein said design means comprises a finite element analysis.

26. A method for making a generally cylindrical insert to transfer a design tension load to a core of a composite structure, the insert having a side wall and a top, the method comprising:
a. designing the insert to have a stiffness of the side wall in an axial dimension, said stiffness of said side wall being selected so as to be greater than said stiffness of a plug of the core;
b. manufacturing the insert consistent with said design.

27. The method of claim 26 wherein said step of designing the insert further comprises: designing the top of the insert to accept the design tension load.

28. The method of claim 27 wherein said stiffness of the side wall is selected to be less than said stiffness of the side wall that will cause a failure of a bond line between the outer wall and the core in response to the design tension load placed on the top of the insert when the side wall is bonded to the core.

29. The method of claim 28 wherein said step of designing the insert further comprises: selecting said stiffness of the top sufficient to prevent a failure of said bond line between the outer wall and the core in response to the design tension load applied to the top of the insert when the side wall is bonded to the core.

30. The method of claim 29 wherein said step of designing the insert further comprises: applying finite element analysis to select said stiffness of the side wall and of the top of the insert.
